(19) United States
(12) Patent Application Publication
(10) Pub. No.: US 2007/0006586 A1
(43) Pub. Date: Jan. 11, 2007

(54) Serving end use customers with onsite compressed air energy storage systems

(76) Inventors: John S. Hoffman, Washington, DC (US); Eric Ingersoll, Cambridge, MA (US); Stephen Chomyszak, Attleboro, MA (US)

Correspondence Address: ELMORE PATENT LAW GROUP, PC, 209 MAIN STREET, N. CHELMSFORD, MA, 01863, US

(21) Appl. No.: 11/472,502

(22) Filed: Jun. 21, 2006

Related U.S. Application Data
(60) Provisional application No. 60/692,510, filed on Jun. 21, 2005.

(51) Int. Cl. F03G 7/00

(52) U.S. Cl. 60/641.2

(57) ABSTRACT

The invention relates to systems for stored compressed air without use of combustion. The systems can be installed on the customer side of the meter and creates electricity during peak hours after it has been stored in off peak hours. The invention creates a financial incentive for conserving energy costs by building compressed air storage systems which heretofore have seen little application.

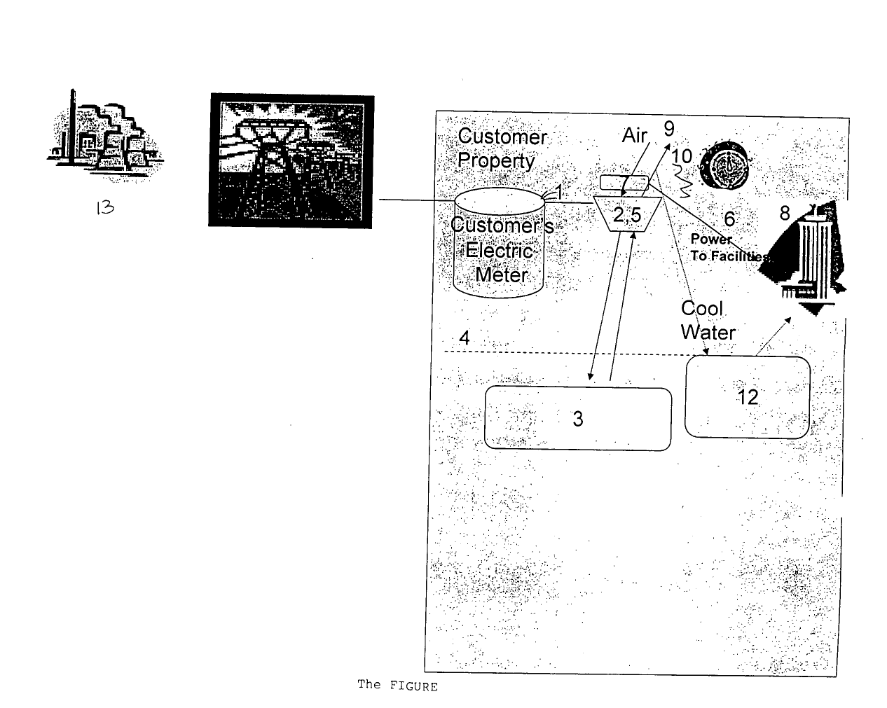

### RELATED APPLICATION SECTION

This application claims benefit of priority to U.S. application No. 60/692,510 filed on Jun. 21, 2005, the teachings of which are incorporated herein by reference.

### BACKGROUND OF THE INVENTION

End users of electricity, also called industrial, commercial and retail ratepayers by load serving entities (utilities that deliver power to the customers' meter), face unfortunate rate structures. During certain hours, usually the day and especially in the summer, load serving entities charge more per kilowatt hour (kWh) for electricity than at night. Additionally, many have a demand charge that is related to the highest power use during the day in a given month of season (a charge per kW of power where the charge might be $16 per kW even though that amount of power was only used for 15 minutes in a month). Since end users generally use more power and electricity during the day than at night, when rates are lowest, their costs for electricity and power are greater than otherwise would be the case. Further, since cooling demands increase during the day as temperatures rise, especially in the summer when rates are highest, the cost of electricity utilities for end users is substantial.

To control costs, end users have employed several strategies. One of the most effective has been to increase the efficiency of the equipment that they use. For example, many end users have joined Green Lights, a US EPA program, in which they reduced their lighting energy use on average by 50% by upgrading their lighting systems from magnetic ballasts to modem electronic ballasts. Such projects typically yielded rates of return exceeding 50%. End users have also installed Energy Star equipment that reduces computer and other ‘appliance’ energy use. End users have improved the shells of their buildings by installing more energy-efficient windows and insulation. Efficient air conditioning equipment and variable frequency drives on fans have also reduced both kWh use and kW use. These strategies entail reducing the energy usage, thereby reducing charges for energy and power demand from load serving entities.

Another solution suggested involves thermal storage of energy in the form of ice or cold water. Taking advantage of low night time rates, these end users would install equipment to store the cold water or ice and then use it for cooling during the daytime.

Still another solution involves building distributed generation (DG), or an end-user power producing plant, that usually also produce hot water (co-generation or combined heat and power) or hot water and cooling in the summer from thermally driven cooling (so-called tri-generation). However, these installations have their own difficulties. Many end users do not want to take on the responsibility of operating these facilities or installing combustion engines. End-users located in regions of high air pollution may find obtaining the necessary air pollution permits impractical. Finally, distributed generation has its own problems associated with idle facilities during the night and much of the day if the generators are to produce power needed for peak times. Compressed air energy storage (CAES) systems have been suggested as part of integrated DG facilities to ameliorate waste and to improve heat rates, although this proposal fails to address the reluctance or inability of end users to host combustion activities.

While CAES systems have been a focus of research for decades, few have been successfully demonstrated at a few sites around the world and all have been intimately connected to electrical generating/combustion systems. CAES systems have not found widespread acceptance anywhere in the world, however, despite the intuitive appeal of CAES in potentially reducing the mismatch between the availability of generation and the demand for power throughout the day and throughout the year. Researchers and advocates of CAES systems have failed in their efforts to win acceptance.

CAES were originally suggested to take advantage of the energy usage differential, as discussed above. In fact, even with the additional economic anomaly that occurs because nuclear power plants and coal plants, which cannot easily be turned on or off during each diurnal cycle, the CAES systems of the prior art have not been built. Since these types of power plants provide a large fraction of the baseload power demand during the day, power production often exceeds demand at night, thereby lowering the price of power during these periods to below the average cost for delivered power. In other words, power plants are run at night in order to be able to be dispatchable during the day, wasting resources and creating unnecessary pollution. Furthermore, since peak demands must be met with electricity dispatched and transmitted and distributed at the time of peak need, transmission and distribution system must be built to accommodate the peak demand, thereby living a large proportion of the Transmission &Distribution (T&D) capital idle much of the rest of the time.

Small volume compressed air storage combined with flywheels have been suggested as a method of creating a short term, uninterrupted power supply (UPS) for electronics and even of being able to provide limited cooling as air is expanded, but the discussion in the literature is not concerned at all with energy savings or management, with integration into the EMP of facilities but with sustaining high quality power. David Morrison, Editor of Power Electronics Technology stated in his article “Leveraging Thermal and Compressed Air Storage” focuses on the value of a system that uses flywheels and compressed air to provide fast back up power. The producer, Active Power, describes their systems as follows: “How does it work? CleanSource XR stores energy in the form of heat and compressed air. During a utility outage, the compressed air is routed through a thermal storage unit to acquire heat energy. The heated air spins a simple turbine-alternator to produce electric power. Air that exits this small turbine is below room temperature and can be used to cool the protected load. Tanks that store the compressed air become cold during discharge, absorbing heat from the ambient environment and ultimately converting this heat into additional backup power. CleanSource XR also contains a small, continuous-duty flywheel that handles small fluctuations in power and supports the critical load during the brief period required for the air turbine to reach full speed in the case of an extended outage. In a White Paper written by John R Sears from Active Power, Sears makes it clear that the purpose of using CAES with a thermal storage and a flywheel is the opposite of using a CAES system to reduce the inflow of power during peak power, clearly indicating that purpose of the Active Power system is to operate when power would not flow to the end user at all. The UPS hybrid discussed in the prior art seeks to REPLACE power that is suddenly interrupted in the flow, not to DISPLACE power that would have flowed at a high cost.

In fact, the failure of CAES technology to move forward, given the negative economic impact for society and users, increasing capital costs for providing energy services, increasing operating costs and increasing pollution, illustrates the failure of current CAES technology to address a vital need of the energy system. Despite more than 30 years of financial support from the US Department of Energy, CAES has had virtually no impact for end users. Thus, customers pay significantly more for power during the day, often paying ‘demand charges’ based on the highest kilowatt (kW) use in a month or even year, in additional to kilowatt hour (kWh) charges based on energy use. The invention that we will describe here is based on the concept that the purpose of the CAES system should be to offer end users the opportunity to reduce their energy and power consumption during periods of high prices by withdrawing energy stored in the CAES system on a customer's site. While the system may benefit the grid and its operators that is an incidental benefit of the proposed CAES invention, CAES on the customer side of the meter. The goal of this invention is to reduce END USER power consumption and energy consumption from the grid when it is available but high priced by withdrawing energy from CAES that has been put there when prices are lower.

It is the premise of the present inventors that the failure of CAES to deliver economic benefits to society or to end users is due to the belief that CAES systems should be built on the “generator side of the meter” and in tandem with combustion processes.

### SUMMARY OF THE INVENTION

This invention relates to development of an Energy Management Program (EMP) for end users to relieve them of high charges for energy and power demand from load serving entities (LSE) with use of compressed air energy storage (CAES) systems that do not need combustion to provide power for peak use on the customer side of the meter, creating a new method of doing business that makes development of CAES systems that are integrated into end user energy management programs (EMP) viable.

Our invention involves using an on-site CAES system which does not rely upon combustion so that end users can readily take advantage of off peak rates. The on-site CAES system can be integrated into the Energy Management Program (EMP) of the end user and can control and reduce the cost of providing services that require energy. “On-site” is defined to mean installation at the location of the end-user, as compared to the load serving entity. This is also referred to herein as being on the “customer side of the meter.” The onsite CAES would be connected to the grid, where generators would use their power stations to produce high voltage electricity. That electricity would then be transferred through high voltage transmission systems to sub stations closer to users. Step down transformers would then distribute the power to end users, through meters. From that point, the electricity would be supplied to the end user facilities through the various electrical panels that then serve individual circuits within end user facilities.

On-site CAES, by allowing power to be stored on-site when rates are lowest and used when demand is high, creates efficiency and offering END USERS direct benefits not available from the prior art. In contrast to prior CAES art, which envisioned them as utility investments in infrastructure rather than end user cost control mechanisms, on-site CAES directly advantages the end user and allows integration of the CAES system to the end user energy systems, including the ‘driver of peak power loads’, the cooling or other uses that increase through the day. CAES systems and technology placed on the generation side of the meter, usually close to the power plant, contribute nothing to reducing peak transmission and distribution capital requirements. Placed on-site, CAES can become economically viable by operating with lower priced electricity (usually off peak) for the storage function and also by eliminating the power plant with combustion as is typically called for in the prior art CAES systems. On site CAES without combustion thereby eliminates the negative environmental impact, health and safety issues associated with CAES, and the adverse reaction from management about the task of taking on the complexities and operational costs associated with power plants. Our invention eliminates the inhibitions that have prevented implementation.

Our invention focuses on using a CAES system on the customer side of the meter without combustion and integrated into the EMP of the facility, so that end users can reduce their costs. The system can be run manually or connected into a building Energy Management System (EMS) that manages the extraction of energy from the CAES to automatically reduce costs. It can be remotely monitored by associates of the end user (headquarter, consultants, suppliers or renters of the CAES system) to assure performance and reduction in energy costs. The system should preferably comprise panels equipped with switchgears that would allow power to flow from the grid into the end user's facilities, from CAES into the end user's facilities, and, optionally, from CAES to the grid. For every kWh extracted from CAES during periods of peak use or high rates, the end user will be able to reduce the power purchased from the grid, with a reduction in the kW or demand charge during the period of peak uses or higher rates. The voltage from CAES preferably would be the same voltage as the end user needs, so that if the power was sold back to the grid it would go through the transformers, if any, before entering the grid.

The system can additionally, or alternatively, be integrated with equipment that capture and use the cooling capacity of CAES that develops when the compressed air is expanded. In contrast to the prior art CAES systems located on the load serving entities side of the meter, the cooling that results from expansion of compressed air would not be lost. In the present invention, end users in need of cooling, such as during the middle of the day when energy costs and demands are at their peak, will be able to efficiently capture and utilize this cooling capacity. Combining the cooling capacity from the CAES with the power generation results from extracting the compressed air will in a complementary energy management system since this cooling scheme can further decrease the energy and peak power requirements of the end user. That is, since the peak charges for the day usually begin early in the morning, before peak power and energy demands develop due largely to daily usage patterns and air conditioning needs, the extraction of energy from the CAES can be managed so that ‘free cooling’ is generated and, preferably, but not in all cases, can be temporarily stored as cold water or ice (or other coolant) and used at the time of day cooling is required. The CAES system can also be integrated to operate with a system of off peak thermal storage in which cool water or ice is stored using off peak power to develop the stored ‘coolth’. Also a large CAES system could be used to start generating power before peak hours and also create coolth that could be stored for use during the period of peak charges. Thus the invention offers a range of options of creating coolant from purchase of off peak power and then using the coolth to reduce peak demands for electricity and thus reduce power use during periods of higher charges for electricity or power. The ability to store the coolant during periods of peak power charges but before periods of peak power demand will offer end users the opportunity to reduce purchases of power during the peak and to reduce their peak power demand and thus reduce their demand charges. Onsite storage will allow management of the system to reduce the total energy used during peak periods and to also reduce the highest amount of power needed from the grid, or both is reduced during peak use. That is, the CAES can be configured to generate coolant during off peak periods (and stored for use during peak periods) or the CAES can be configured to generate coolant as a by-product of power generation during peak rate periods, but before peak energy and power use occur. Such use of ‘coolth’ could in some situations totally eliminate power consumption during periods of peak rate or high rate use, should such a goal be desired as part of the EMP.

In taking this approach, financing a CAES system will be much easier since the economics are improved by the projects ‘seeing’ not wholesale generation costs, but the full cost of transmission and distribution costs as experienced in retail rates and for allowing the end user to integrate the CAES system into their EMP. Location on the customer side of the meter also allows direct connection to computerized EMS, allowing for economic improvement and even optimization for end users. Use of CAES on the customer side of the meter allows more than peak shaving, that is, small incremental reductions in peak power use, but potentially even allows the complete elimination of use of power purchases during higher daytime peak prices, not just those closest to the actual peak use of electricity.

Thus the technical and economic advantages of the invention include:
Reduction in losses associated with ‘round tripping’ the storage and then extraction of the energy CAES systems since the coolth of the system during expansion can be used by end users;
Improved power factor because the power is generated near the end user;
Potential to integrate cooling capacity from taking energy out of the CAES system in such a way as to decrease costs of capital for the CAES system and the host air conditioning capital and operating budgets, including the potential to optimize such systems;
Integration with the Energy Management Program and Energy Management Systems, along with use of remote monitoring by end users for optimizing CAES utilization, including in demand reduction programs offered by utilities or in aggregate purchasing headquarters operations may create with scattered sites used by end users allows major cost savings for end use, including capital costs for equipment, operating costs and costs associated with purchasing power and electricity from various buyers; and
Improvements in the ability to finance CAES systems.
   Indeed, the CAES systems and technology developed to date have seen few applications because they are large, difficult to finance and reimbursed from the wholesale market. Given the relatively lower prices in that market, the economics of the technology and business models that CAES has been based upon are risky and unattractive.

The invention provides benefits for the grid system as a whole, including:
The ability to utilize capital that is relatively “idle” (transmission and distribution lines) at night (or at other times of low load);
The ability to utilize excess power production at night or other low load times;
The ability to utilize the potential for cogeneration of cooling when expansion does take place, thereby decreasing demand;
The ability for CAES projects to reduce the need for expensive investments in transmission and distribution and peaking generating capacity.

Solving these problems could create a strong market potential for CAES and greatly improve the economics, reliability and pollution characteristics of the whole power system.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

The FIGURE illustrates the invention and includes an onsite compressor air energy storage system that would be placed near customers (consumers) of power and would be capable of providing cooling capacity as the air was expanded.

### DETAILED DESCRIPTION OF THE INVENTION

A description of preferred embodiments of the invention follows.

Referring to the FIGURE, the CAES system is built on the customer side of the meter 1 (i.e., “on-site”). This system consists of a compressor 2 that compresses a fluid, such as air, into storage container 3 that is, optionally, buried in the ground 4. The container is capable of withstanding high pressures. An expander 5 expands the compressed air when power is needed, usually during the period of peak power demand as indicated on the clock 6. The compressor 2 and expander 5 could be the same device or separate devices. The expander is operably connected to a generator 7, which converts the energy stored as compressed air into electricity. Power is then provided to the customer's facilities, using a generator that is part of the designed system to do so, preferably using low voltage suitable for the host facility 8. Cooling can also be extracted from the expanding air stream 9 and cools water in the water stream 10 via heat exchanger. The water is either used immediately for cooling or is stored for later use. This displaces the demand for power for air conditioning, especially at peak temperatures and demand.

The compressor would preferably be one or more toroidal intersecting vane machines such as described in Chomyszak, U.S. Pat. No. 5,233,954, issued Aug. 10, 1993, U.S. application Ser. No. 10/744,230, filed on Dec. 22, 2003, PCT/US2004/042904, filed on Dec. 22, 2004 and Tomcyzk, United States Patent Application Publication 2003/0111040, published Jun. 19, 2003, which are incorporated herein by reference. Other compressors can also be used.

The toroidal intersecting vane compressor can comprise a supporting structure, a first and second intersecting rotors rotatably mounted in said supporting structure, said first rotor having a plurality of primary vanes positioned in spaced relationship on a radially inner peripheral surface of said first rotor with said radially inner peripheral surface of said first rotor and a radially inner peripheral surface of each of said primary vanes being transversely concave, with spaces between said primary vanes and said inside surface defining a plurality of primary chambers, said second rotor having a plurality of secondary vanes positioned in spaced relationship on a radially outer peripheral surface of said second rotor with said radially outer peripheral surface of said second rotor and a radially outer peripheral surface of each of said secondary vanes being transversely convex, with spaces between said secondary vanes and said inside surface defining a plurality of secondary chambers, with a first axis of rotation of said first rotor and a second axis of rotation of said second rotor arranged so that said axes of rotation do not intersect, said first rotor, said second rotor, primary vanes and secondary vanes being arranged so that said primary vanes and said secondary vanes intersect at only one location during their rotation. Similarly, the toroidal intersecting vane expander is self-synchronizing.

Preferably, the compression is achieved in multiple stages, although a single stage compression is possible.

The compression is preferably done with the injection of a fluid that allows isothermal compression or substantially isothermal compression, although this is not necessary. Substantially isothermal compression produces a highly efficient thermodynamic cycle. Examples of fluids that can be used include air. The fluid can be a recycled fluid (where the fluid was used in a prior compression). However, the use of air generally avoids the need to recycle the fluid.

The compressor is operably linked to at least one power source, such as utility supplied electricity sourced from the utility side of the meter 13. Alternatively, the power source can be a solar panel. In a particularly preferred embodiment, the power source is not a combustion engine.

While a single storage containers and compressor and expander can be used, a plurality of storage tanks and compressor, expander in order to assure redundancy, reliability, availability and to avoid demand charges for equipment failure.

The storage containers can be accessed in series or in parallel, can be the same or different sizes. The containers can optionally be insulated to reduce heat loss or not insulated to facilitate heat loss.

The compressed fluid (e.g., air) can be stored in an underground void (such as a cave or mine), although it will often be preferable to store in a tank above or preferably below ground. In one embodiment, the tank is mobile (e.g., a truck). The container is preferably designed to withstand a variety of possible pressures. The size of the container and the pressures that it is designed to withstand are related to the energy capacity of the system. Where size of the container is a limiting design factor, the container can be designed to withstand about 150 atmospheres or more.

The storage container and, optionally, other components of the on-site CAES systems could be buried deep enough to be attack-proof or resistant.

The compressed fluid is then expanded through an expander. The expander would preferably be one or more toroidal intersecting vane machines such as described in Chomyszak, U.S. Pat. No. 5,233,954, issued Aug. 10, 1993, U.S. application Ser. No. 10/744,230, filed on Dec. 22, 2003, PCT/US2004/042904, filed on Dec. 22, 2004 and Tomcyzk, United States Patent Application Publication 2003/0111040, published Jun. 19, 2003, which are incorporated herein by reference.

For example, the toroidal intersecting vane expander comprises a supporting structure, a first and second intersecting rotors rotatably mounted in said supporting structure, said first rotor having a plurality of primary vanes positioned in spaced relationship on a radially inner peripheral surface of said first rotor with said radially inner peripheral surface of said first rotor and a radially inner peripheral surface of each of said primary vanes being transversely concave, with spaces between said primary vanes and said inside surface defining a plurality of primary chambers, said second rotor having a plurality of secondary vanes positioned in spaced relationship on a radially outer peripheral surface of said second rotor with said radially outer peripheral surface of said second rotor and a radially outer peripheral surface of each of said secondary vanes being transversely convex, with spaces between said secondary vanes and said inside surface defining a plurality of secondary chambers, with a first axis of rotation of said first rotor and a second axis of rotation of said second rotor arranged so that said axes of rotation do not intersect, said first rotor, said second rotor, primary vanes and secondary vanes being arranged so that said primary vanes and said secondary vanes intersect at only one location during their rotation. Where a TIVM is employed, the compressor and expander can be the same device or devices.

Like the compression step, the expansion step can, optionally, be isothermal or substantially isothermal. In a particularly preferred embodiment, the expansion step results in a substantial cooling of the compressed fluid. The cooled, or expanded, fluid can be advantageously used for cooling, such as by directing the expanded fluid through a heat exchanger to cool another material (a coolant) which, in turn, is used for cooling, or used directly as a coolant. In this embodiment, the heat exchanger, thus, cools a coolant. The coolant can be a variety of materials and includes water, ice, a refrigerant Whether the coolant is the expanded fluid from the CAES or is a cooled material generated from heat exchange with the expanded fluid from the CAES, the coolant can be used, for example, in an air conditioning system for the end user.

The coolant can be generated during peak demand for air conditioning or it can be generated in advance and stored. However, since expansion, for the purposes of power generation, is preferably performed during peak demands when air conditioning is also at a peak demand, the coolant generation delivers a “synergistic” impact.

Generating coolant can also be performed during off peak periods. This embodiment can decrease the size or capacity of the CAES system need to reduce peak power and energy use during peak rate periods. In this embodiment, the coolant can be stored for use later in the day. Such a cool water or ice storage system can be optimized for producing greatest economic advantage or rules of thumb could be used to produce a preferred but sub-optimal configuration that is still better than not using a cooling and/or cooling storage system. The process will require the calculation of the cost of paying higher demand charges and higher electricity charges, the cost of CAES storage systems of different sizes, the costs of plumbing or other means to deliver the coolth to the end user facilities, the cost of building and operating storage systems to store ‘coolth’ created both during the expansion process of extracting energy from the CAES and possibly from other means of cooling in off peak hours such as using the chiller or cooling tower or any number of other means to create stored coolth. These numbers than can be evaluated by options and in some cases optimized by a variety of techniques, including hill climbing, linear or dynamic programming or instead a heuristic approach can be developed which merely seeks to improve costs but does not necessary reach the optimal solution.

In another embodiment, the cooling step can be via more conventional means, employing the expansion step as the power source to provide power. A variety of cooling approaches can be used, such as chillers, ground source heat pumps, evaporative coolers, cooling towers, or other means.

In one embodiment, the cooled water can be used in the compression process, creating a closed loop. Preferably a mathematical routine would be used to increase the productivity of the system, preferably but not necessarily an optimizing routine. These other means of cooling can be also incorporated into the decision assisting tools described above. Solar power could also be used to increase the output of the system, with a variety of means to heat the air that would enter the expander, including but not limited to heliostats. The primary storage tank or tanks could be used for the solar heating, including having them above ground. Other sources of additional heating of the air are possible, including waste heat, geothermal and any other source heat available on the site.

Controls are used to assure high efficiency and safe operation. The controls can consider the need for more stored thermal energy based on prior weather data or on weather data fed to the system, either on site or preferably from a remote location.

The CAES system is preferably connected to the Energy Management System of the end user, allowing optimal use of the capabilities of CAES to meet the service needs of end users at lower cost, although this is not strictly necessary. Similarly, the CAES system may be remotely monitored and controlled, thus allowing an entity to manage its overall energy use strategy to best meet its service and cost objectives. Since organizations differ in their management strategy, some preferring local facility control, others preferring centralized control, the ability to remotely measure provides a means for the decentralized system to evaluate performance at local cites and for centralized systems to actually make decisions and when logical, integrate the decisions at a variety of sites to reach desired economic goals such as using only so much peak power from all its facilities as part of purchase agreement or a power curtailment agreement with load serving entities. Remote monitoring would use any of a variety of communication paths, including direct phone lines, the internet, radios, cell phones or other telecommunication or physical means. Many organizations have Energy Management Plans (or plans with different names such as Energy Plans or Facility Plans), formal or informal, aimed at reducing their overall costs of purchasing energy utilities. Such plans can embrace a wide variety of options, discussed earlier, from improving lighting to preventive maintenance on equipment to make it run better. The plans can involve deciding who to purchase electricity, power supply, even thermal services such as heating and cooling. Even the simplest end users have an Energy Management Plan, if only to purchase all their needs from the local load serving entities. An energy management system is part of a more sophisticated Energy Management Plan and includes a means to track power or machines use, often with a series of sensors that measure performance at designated points and then transfer this information to a computer system where it can be displayed, used for decision making, transferred to still another location and in some cases archived and stored for later analysis. Energy management systems are also called Building Management Systems, Facility Management Systems, Monitoring, and Monitoring and Control Systems. CAES would be incorporated into these systems by tracking such values as total stored air, realizable power for use during the peak or high cost power/electricity periods, available cooling from expansion, and other important characteristics that would then allow end users to manage the CAES system to reduce costs and provide services desired.

The CAES system operably links the expander to a generator to supply power, preferably at the voltage needed in the end users facilities without transformers, although transformers or power electronics can be used to assure proper voltage regulation. The power thus produced can be used by the end user to decrease power demand during peak hours.

The system can be operated by a third party, as in a remote monitoring system, for example, through a contractual arrangement with the end user, although other ownership and contractual relationships are possible, including ownership by generators or load serving entities. Any pricing agreement would be acceptable, but preferably the end user would be given a price below whatever was being offered directly off the grid by the load serving entities and generators. This charge could be contractually arranged to assure regulatory compliance with all state or Federal regulations to avoid becoming a utility, but preferably a system of charges would be developed that reflected the energy and demand charge savings that the customer for the stored power would benefit from. Utilities could also own the onsite CAES system as could the system host or any other owner.

Arrangements for installation of the CAES could be done without any payment to the host, but preferably the owner of the CAES system would pay the host for the right to build the system. The advantages of this immediate payment to a host would be large. Unfortunately, facility managers operate under poor budgets and often require paybacks of 2 or fewer years to make investments. Many issues compete for their time and attention. Paying the owner for installing the CAES provides a strong incentive to gain the ‘mindshare’ needed to get the attention of the facility manager/owner by creating an immediate positive cash. Preferably coupled with guaranteed lower priced electricity such an approach to developing CAES systems on the customer side of the meter is likely to play a decisive role in this technologies success. The owner could also be the host themselves and purchase CAES systems and associated programs to integrate best to the EMP and the EMS, although sales could also be made with this integration being part of the sales package.

Additional CAES power could be stored so that the system performed the function of Uninterrupted Power Supply. Preferably additional charges would be created for this function.

Many variations of an end user service CAES system are possible. One system can be designed to eliminate all daytime (peak) energy use by itself. This would require a CAES system of sufficient size to meet not just the total electricity demand but to meet the peak demand as well. In one embodiment, a system designed with storage of cool water during the early part of the day for use later in the day can be used. The invention also includes a system in which night time electricity or electricity bought at lower rates could be used to fill the thermal storage with ice or water using any of a variety of cooling approaches such as chillers, ground source heat pumps, evaporative coolers, cooling towers, or other means. This would also allow the size of the CAES system to be reduced. By using existing or new capital equipment to store coolth during off peak hours the demand for peak power can be reduced, thereby reducing the size of the CAES that would be needed to reduce or to avoid peak charges. Of course, these described cases are only a small subset of the possible arrangements for an end user, on-site CAES system. Many other combinations and permutations can be created.

In one business model, utilities could be induced to pay the host or the CAES operator a direct payment for reducing peak demand and/or eliminating transmission/distribution bottlenecks or costs of building additional capital equipment, although this is not always necessary for the successful operation of the system or business, and no payments would certainly be acceptable in some regions.

The benefits of the stored energy on site accrues to the whole grid and any connected grid, reducing vulnerability of blackouts, brownouts and the need for investment in peak related capital equipment. This is true for any CAES system capable of serving a grid.

Onsite CAES storage can be critically important in areas serviced by large nuclear or fossil plants, by providing a means to use night time energy more effectively. Preferably a financial arrangement between such generators and CAES owners or operators would be developed. This could be especially true for the new coal gasification systems, whose future depends on improving economics, but could also apply to wind energy, ocean current or thermal energy or any other renewable sources of energy, such that might gain from onsite CAES systems because they produce power when prices are normally low and preferably there would be a financial arrangement with such generators for the CAES onsite owners. This arrangement could be for long term contracts to purchase the power produced when prices where low, thus providing those producers with greater potential revenue and improved ability to finance. In this regard, PCT 04/43504 filed on Dec. 23, 2004 in the name of Eric Ingersoll is incorporated herein by reference. This patent describes the use of a CAES system in conjunction with wind energy, for example.

Onsite energy stored in CAES could also be sold back to grid; preferably a system of doing so would be worked out to create further energy benefits for the society and the owners and hosts of the onsite CAES project. Thus, in one embodiment, the invention includes a method for monitoring electricity sold.

Onsite storage is also possible by moving a mobile entity that has a CAES system to a site. This system could supply power, preferably but not necessarily in emergencies, to entities that lost power or suddenly needed power. It could also be used when the grid became irregular or the price of electricity shoot up to enormous proportions. It could also be used to replace distributed generation that is ‘down’ so as to avoid high demand charges. Movable CAES systems providing onsite energy could be especially important in areas of environmental sensitivity where generators were not desirable. Movable systems might include a compressor and expander, a compressor/expander as the TIVM machine provides, or expander alone, with the compression being done at a host site elsewhere.

While this invention has been particularly shown and described with references to preferred embodiments thereof, it will be understood by those skilled in the art that various changes in form and details may be made therein without departing from the scope of the invention encompassed by the appended claims.

What is claimed is:

1) A CAES system connected to a grid that is comprised of power stations generating electricity, transmission and distribution lines, transformers in which kWh extracted from the compressed air storage for use by an end user reduces the electricity that must be purchased by the end user during peak or higher cost hours comprising a compressor, expander, generator and storage container wherein the compressor is operably linked to a customer electric meter such that the electric meter drives the compressor such that the compressor compresses a fluid into said storage container, the expander is operably linked to said storage container such that the release of the compressed fluid there from drives the expander and said expander is operably linked to said generator.

2) A CAES system of claim 1 in which kW extracted from the compressed air storage reduces the demand charge from the load serving entity during peak or higher cost hours.

3) A CAES system of claim 1 where cooling is extracted from the expansion process for use in end users facilities.

4) The system of claim 1 where the cooling is stored.

5) The system of claim 1 where the stored cooling is used to decrease the size of the CAES needed to meet a targeted reduction in demand.

6) A CAES system according to claim 1 where the output voltage is below 1000 volts.

7) A CAES system built on the customer side of the meter, comprising a compressor and expander.

8) The system of claim 7 that uses a single piece of equipment to perform the compression and expansion.

9) The system of claim 7 that uses substantially isothermal compression.

10) The system of claim 7 that uses substantially isothermal expansion.

11) The system of claim 7 that allows fluids to be cooled in expansion for use in air conditioning.

12) The system of claim 7 that allows fluids to be cooled in expansion to be stored for later use in air conditioning.

13) The system of claim 7 that allows fluids to made into cooled solids for storing thermal energy for later cooling.

14) The system of claim 7 that stores the compressed air in buried containers.

15) The system of claim 7 that stores the compressed air in caverns.

16) The system of claim 7 that allows the owner of the compressed air system to sell electricity to the customer or charge the customer for its use or holding.

17) The system of claim 7 with a single tank.

18) The system of claim 7 with multiple tanks and multiple compressors/expanders.

19) The system of claim 7 with insulation on the tank or tanks.

20) The system of claim 19 that allows a savings for the customer from the retail price of power.

21) The system of claim 7 that allows the owner of compressed air system to sell the stored energy as power back to the grid.

22) The system of claim 7 that allows the owner of the compressed air storage system to receive payments from the grid operators, load serving entities, or any other party to the maintenance and operation of the grid and grids connected to the grids.

23) The system of claim 7 that allows the cooled fluid to be stored in an underground holding area.

24) The system of claim 7 that allows the owner of the compressed air energy storage system to pay the host a fee or fees for entering into a contract for selling or holding the power for the host.

25) The system of claim 7 that allows a charge for uninterrupted power or the use of the system for that purpose.

26) The system of claim 7 where available heat sources are used to increase the output of the CAES systems.

27) The system of claim 26 where that source is solar energy.

28) The system of claim 26 where the source if geothermal energy.

29) The system of claim 26 where the source of energy is waste heat from some process on the site.

30) The system of claim 7 where distributed onsite energy is used to compress the air.

31) The system of claim 7 where the CAES system is connected to the energy management system of the end user.

32) The system of claim 7 where the CAES system is connected to a remote monitoring system.

33) The system of claim 7 where a mathematical routine or program is used to manage the CAES system.

34) The system of claim 33 where the routine or program is an optimization program.

35) The system of claim 30 where the onsite energy is a power station.

36) A CAES system of claim 1 wherein the storage container is located on a mobile unit.

37) The system of claim 36 for charging those needing power temporarily for the delivered power.

38) The system of claim 36 wherein the compressor and expander are located on a mobile unit.

39) A CAES system of claim 1 further comprising a combustion source used for generating energy.

40) The system of claim 39 that uses a single piece of equipment to perform the compression and expansion.

41) The system of claim 39 that uses substantially isothermal compression.

42) The system of claim 39 that uses substantially isothermal expansion.

43) The system of claim 39 that allows fluids to be cooled in expansion for use in air conditioning.

44) The system of claim 39 that allows fluids to be cooled in expansion to be stored for later use in air conditioning.

45) The system of claim 39 that allows fluids to made into solids for storing thermal energy for later cooling.

46) The system of claim 39 that stores the compressed air in buried cylinders.

47) The system of claim 39 that stores the compressed air in natural or artificially created caverns.

48) The system of claim 39 that allows the owner of the compressed air system to sell electricity to the customer or charge the customer for its use or holding.

49) The system of claim 39 with a single tank.

50) The system of claim 39 with multiple tanks and multiple compressors/expanders.

51) The system of claim 39 with insulation on the tank or tanks.

52) The system of claim 39 that wherein the CAES system is operably connected to the grid to allow energy resale.

53) The system of claim 39 that allows the cooled fluid to be stored in an underground holding area.

54) The system of claim 39 further comprising a switch that allows uninterrupted power service.

55) The system of claim 39 where available heat sources are used to increase the output of the CAES systems.

56) The system of claim 55 where that source is solar energy.

57) The system of claim 55 where the source if geothermal energy.

58) The system of claim 55 where the source of energy is waste heat from some process on the site.

59) The system of claim 55 where distributed onsite energy is used to compress the air.

60) The system of claim 55 where the CAES system is connected to a energy management system of the end user.

61) The system of claim 39 where the CAES system is connected to a remote monitoring system.

62) The system of claim 39 a where a mathematical routine or program or a logical procedure is used to manage the CAES system.

63) The system of claim 62 where the routine or program is an optimization program.

64) A CAES system directly connected to the end users facilities.

65) The system of claim 64 where the connection is in series from the entering meter to the CAES to the facilities of the end user.

66) The system of claim 65 where the connection includes switchgear that allows power to be routed from the CAES either to the end users facilities or back to the grid.
